(19) United States
(12) Patent Application Publication
(10) Pub. No.: US 2021/0299691 A1
(43) Pub. Date: Sep. 30, 2021

(54) DETECTIVE SPRAYER

(71) Applicant: David Noorie, San Diego, CA (US)

(72) Inventor: David Noorie, San Diego, CA (US)

(21) Appl. No.: 16/830,584

(22) Filed: Mar. 26, 2020

(51) Int. Cl. B05B 12/08; H04N 5/225; H04N 5/232; H04N 5/76

(52) U.S. Cl. CPC B05B 12/08; H04N 5/2253; B60R 11/04; H04N 5/76; H04N 5/23299

(57) ABSTRACT

A detective sprayer system for helping identify vehicles leaving the scene of a hit and run accident is present. In traffic laws, a hit-and-run is the act of causing a traffic accident and not stopping afterwards. It is considered a supplemental crime in most jurisdictions. The detective sprayer system is useful for providing video of an accident and license plate visuals. The detective sprayer system may also be able to mark the offender of a hit and run event by spraying the offender's vehicle with a colored spray. The detective sprayer system has a camera, sensor, plurality of sprayer assemblies and a cabling assembly.

### FIELD OF THE INVENTION

This invention relates to automobiles. More particularly, it relates to automobile safety and security.

### BACKGROUND

In traffic laws, a hit-and-run is the act of causing a traffic accident and not stopping afterwards. It is considered a supplemental crime in most jurisdictions.

Legal consequences of hit-and-run may include the suspension or cancellation of one's driver's license; lifetime revocation of a driver's license is possible in certain jurisdictions. It is frequently considered a criminal offense which can be punished by fines and imprisonment. Insurance companies often raise the insurance costs or even void the policies of drivers involved in this offense.

The penalties and the definition) of hit-and-run vary from state to state in the United States. For example, in Virginia, the crime is a felony if the crash causes death, injury, or damage to attended property in excess of a certain dollar amount; otherwise, it is a misdemeanor. In California the crime can be an infraction, a misdemeanor, or a felony depending on whether there is property damage or bodily injury.

In Texas, the crime is a third-degree felony if the collision involves a fatality or serious bodily injury. Collisions causing less serious injuries are punishable by imprisonment in the Texas Department of Criminal Justice for not more than five years, or confinement in the county jail for not more than one year, a fine not to exceed $5,000, or both. Collisions causing $200 or more in total damages without injuries are punishable by a class B misdemeanor, and collisions causing less than $200 in total damages are a class C misdemeanor.

In New York, leaving the scene of an incident without reporting it is a traffic infraction, and if personal injury is involved, then it becomes a misdemeanor. There are also significantly higher fines if an animal is injured in the hit and run crash.

One of the major issues in a hit and run accident is that reliance on others to witness and provide definitive information to a police officer is suspect. Therefore, there is a need for a safety and security systems for an automobile that can provide positive identification of others that may affect a hit and run accident.

### BRIEF DESCRIPTION OF THE DRAWINGS

FIG. 1A is an illustrated view of a detective sprayer system.

FIG. 1B is an illustrated view of an exemplary sprayer assembly of the detective sprayer system as shown in FIG. 1A.

FIG. 1C is an illustrated view of an exemplary camera assembly of the detective sprayer system as shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

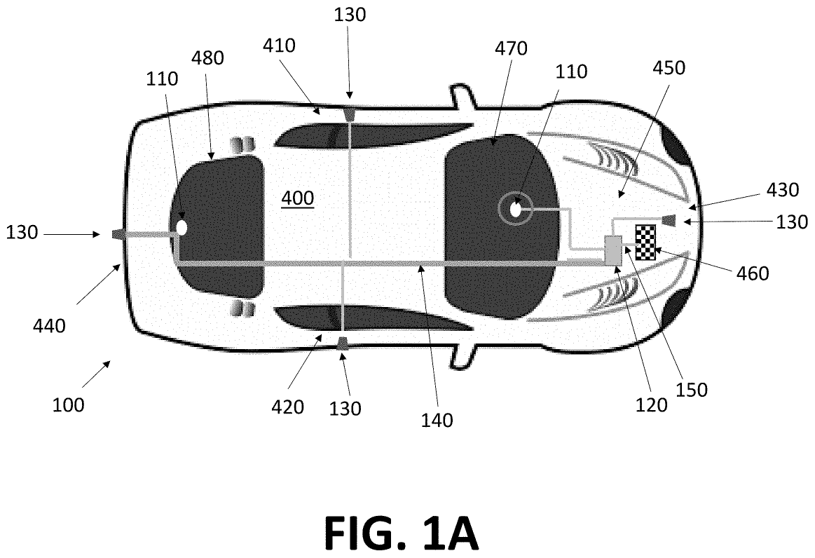

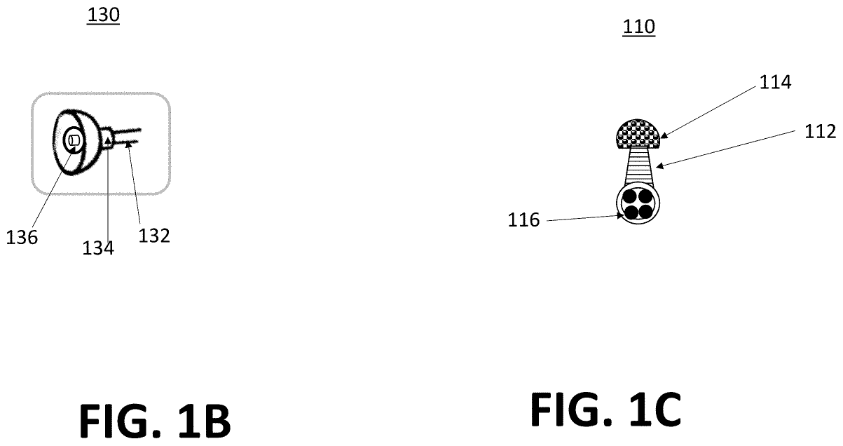

Referring to FIG. 1A, an illustrated view of a detective sprayer system 100 for providing identification upon an accident is presented. The detective sprayer system 100 is useful for providing video of an accident and license plate visuals. The detective sprayer system 100 may also be able to mark the offender of a hit and run event by spraying the offender's vehicle with a colored spray.

The detective sprayer system 100 is coupled to a vehicle 400. The vehicle 400 is preferably an automobile but other types of vehicles are contemplated such as, but not limited to, pick-up trucks, sport utility vehicles (SUVs), motorcycles, etc.

The vehicle 400 has a driver side 410, a passenger side 420, a front bumper area 430, a back-bumper area 440, a hood 450, a power source 460, a front windshield 470 and back windshield 480.

The power source 460 provides power to the vehicle 400 and to the detective sprayer system 100. The power source 460 is preferably a twelve (12) volt power source such as a car battery, but other power sources are contemplated such as, but not limited to, solar, Nicad, etc. The power source 460 is internal to the vehicle 400 and is generally located under the hood 450 of the vehicle 400.

The detective sprayer system 100 has a camera assembly 110, a sensor 120, a plurality of sprayers 130, a cabling assembly 140 and a wiring assembly 150.

The wiring assembly 150 is coupled to the sensor 120 and to the power source 460. The wiring assembly 150 carries the electrical current from the power source 460 to the sensor 120 such that the sensor 120 is powered and can detect and act upon that which it senses.

FIG. 1B further illustrates the sprayer assemblies 130. The sprayer assemblies 130 is coupled to the sensor by the cabling assembly 140. The cabling assembly is communicatively coupled to a casing of the sprayer assembly 130. The casing 134 further houses a reservoir of liquid for spraying by the sprayer 136. The liquid in the reservoir is preferably an ink. The sprayer 136 is activated and fed the liquid when a command is received by the sprayer assembly 130 to activate spraying.

When the sensor 120 detects a collision, the sensor 120 sends a command to spray to one of the plurality of sprayer assemblies 130. The sensor 120 is communicatively coupled to the plurality of sprayer assemblies 130 by the cabling assembly 140. The plurality of sprayer assemblies 130 preferably sprays an offending vehicle with a colored spray such that the vehicle can later be identified. The sprayer assemblies 130 are coupled to the driver door 410, the passenger door 420, front bumper area 430 and back bumper area 440.

Optionally and/or additionally, the liquid may further have an odor additive such that the offending vehicle can be visually detected with the ink or can be detected by the odor additive added in the ink. The sensor 120 may command only one or any number of the sprayer assemblies 130 to spray the liquid.

FIG. 1C illustrates a further view of the camera assembly 110. The camera assembly 110 has a camera 114 and a storage module 112. The storage module 112 is interior to the camera assembly 110. The storage module 112 is preferably accessible, but other accessing means is contemplated such as, but not limited to, capture using IEEE 802.11 (WiFi) signaling, 3GPP signaling, 5G Wireless signaling, signaling over a wire, DVR, SD, etc.

The camera 114 is preferably a dashcam, but other types of cameras are contemplated. The camera 114 is preferably equipped with G-sensor such that a recording of a collision is not overwritten by new data. The camera 114 is preferably able to swivel to 360°, but other swivels are hereby contemplated such as, but not limited to 270°, 180°, 225°, adjustable swivel capabilities, etc.

The camera assembly 110 is coupled to the sensor 120 by the cabling assembly 140. The sensor 120 sends commands to the camera assembly 110, using the cabling assembly 140, initiating it to start recording an event. The camera assembly is preferably coupled to the front windshield 470 of the vehicle and substantially near the back windshield 480 of the vehicle 400.

The camera assembly 110 is coupled to the vehicle 400 by one or more couplings 116. The one or more couplings 116 of the camera assembly 110 are preferably suction cups, but other types of couplings are hereby contemplated including, but not limited to, two-sided tape, etc.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A detective sprayer system for identification of accident offenders, the system comprising:
a vehicle, the vehicle for housing the detective sprayer system;
a sensor, the sensor for detecting a collision;
a power source, the power source for providing electrical current, the power source being coupled to the sensor;
a camera assembly, the camera assembly having a camera and a storage module, wherein the camera assembly being communicatively coupled to the sensor wherein the camera being for recording and storing a video;
one or more sprayer assemblies, the one or more sprayer assemblies communicatively coupled to the sensor, wherein the one or sprayer assemblies having a reservoir of liquid and a sprayer; and
wherein when the sensor detects an event the sensor sending a command to the camera assembly to activate, and wherein the sensor sending a command to the one or more sprayer assemblies to spray the liquid from the reservoir.

2. The system of claim 1, wherein the liquid in the reservoir being ink.

3. The system of claim 2, wherein the liquid in the reservoir having an odor additive.

4. The system of claim 1, wherein the sending of the command to the one or more sprayer assemblies directs only one of the one or more sprayer assemblies to spray the liquid.

5. The system of claim 1, wherein the recording by the camera assembly being stored on a DVR.

6. The system of claim 1, wherein the recording by the camera assembly being stored using IEEE 802.11 (WiFi).

7. The system of claim 1, wherein the one or more sprayer assemblies being coupled to each of the sides of a vehicle.

8. The system of claim 1, wherein the vehicle being an automobile.

9. The system of claim 1, wherein the vehicle being a pick-up truck.

10. The system of claim 1, wherein the vehicle being a motorcycle.

11. The system of claim 1, wherein the vehicle being a sports utility vehicle (SUV).

12. The system of claim 1, wherein the camera being swivable to 360°.
